(19) United States
(12) Patent Application Publication
(10) Pub. No.: US 2007/0294296 A1
(43) Pub. Date: Dec. 20, 2007

(54) Constituent data and transaction system

(76) Inventors: David S. Silver, Annapolis, MD (US); Paul K. Brooks, Chevy Chase, MD (US)

Correspondence Address: Paul K. Brooks, Unit 1815, 4515 Willard Avenue, Chevy Chase, MD, 20815, US

(21) Appl. No.: 11/448,837

(22) Filed: Jun. 8, 2006

(51) Int. Cl. G06F 7/00

(52) U.S. Cl. 707/104.1

(57) ABSTRACT

A method of creating and maintaining an organization membership data base which is easily updated and accessed for solicitation and attendance purposes.

### BACKGROUND AND SUMMARY OF THE INVENTION

The invention relates to the design and application of an automated uniform system and related business processes for organizations engaged in: the research and maintenance of relationships; compilation of information pertaining to constituencies; marketing and solicitation functions; gift processing operations; and financial recordkeeping and reporting protocol.

Colleges, universities and other educational institutions, social, religious and political organizations, and other constituent and membership-focused enterprises depend on readily accessible and usable information on constituencies for: relationship building, event planning, fundraising and other grass roots strategies. A cost-effective on-line system used across internal institutional operating boundaries provides: a significant advantage in reducing operating costs, facilitates and promotes consistency in ongoing communications with constituencies, permits refinement of targeted marketing strategies and promotes complete and accurate recordkeeping and reporting of financial measures of performance.

Cash and manpower expenditures associated with the acquisition, maintenance and upgrading of a fast, efficient, knowledge-based system are prohibitive for many institutions. Function-specific outsourcing of constituent data management can limit operating overhead and facilitate superior constituent communication and services.

An interactive knowledge-based technology system maximizes cost-effective data transmission, internally and externally, for advertising and other mailings and for maintaining complete and accurate information on constituents. This automated system assists in segmenting constituent groups and in identifying patterns in fundraising and prospective donors who do not currently contribute to an institution.

This automated system is designed to generate response and follow-up communications, such as acknowledgements or thank you letters, pledge statements, reminders and receipts, as part of a fundraising project. Depending on the nature of the fundraising goals and donor's desires, this automated system accommodates the designation of specific finds to appropriate internal accounts for gift processing, accounting and reconciliation purposes.

Other aspects of the present disclosure will become apparent from the following descriptions of a preferred embodiment when considered in conjunction with the accompanying drawings.

### BRIEF DESCRIPTION OF THE DRAWINGS

FIG. 1 is a schematic of an operating system to accomplish the goals of the invention.

FIG. 2 is a typical listing of information on potential donors.

FIG. 3 describes how a solicitation takes place.

FIG. 4 describes the interrelationship between the solicitor, credit card company and organization.

FIG. 5 describes direct solicitation and receipts of donations and how they are processed by the system.

FIG. 6 describes an illustrative approach to insure compliance with industry, legal and other applicable standards.

FIG. 7 shows a possible use of the system in a university setting.

### DETAILED DESCRIPTION OF THE DRAWINGS

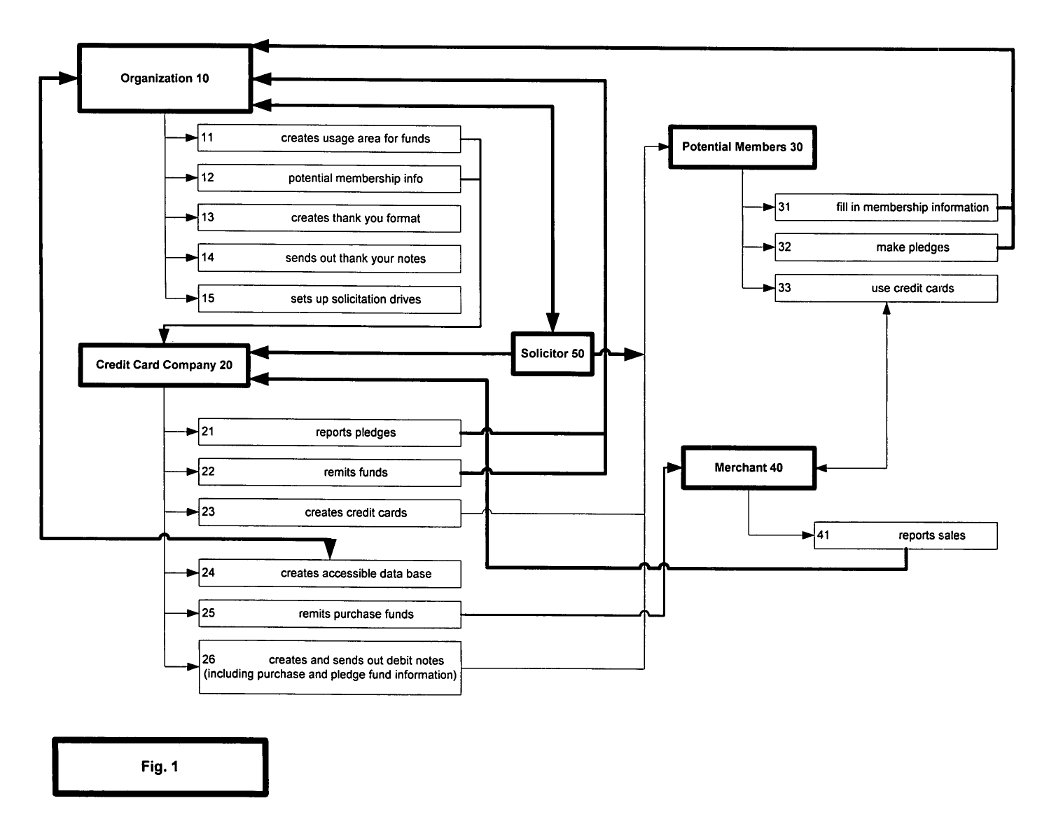

The schematic of FIG. 1 shows the general overall system of the invention. An organization 10 desirous of having an automated system for solicitation from its donor member(s) 30 will create a listing of all possible usage areas for solicited finds such as:
Unrestricted Gifts
Temporarily Restricted Donations
Permanently Restricted Donations
President's Discretionary Account
Athletic area:
   football
   mens basketball
   womens basketball
   gymnasium
English Department
Scholarship Fund
Building Maintenance
Founders Day
New Building
etc.

While we have listed some fourteen plus different areas for solicited funds, we recognize that most organizations 10 can have hundreds of different areas that are recipients of charitable gifts. Each organization 10 will need to customize its own listing. In developing its listing, an organization 10 will most likely use an existing “chart of ftnds” or an accounting “chart of accounts” as a framework for developing its own customized listing. A separate listing for each area and use should be provided. The system will provide for expansion and allow an organization 10 to add additional entries to its listing or “chart of accounts” after the system has been initially set up. An organization such as a university may provide separate accounts for each of its schools as well as a total figure for all accounts.

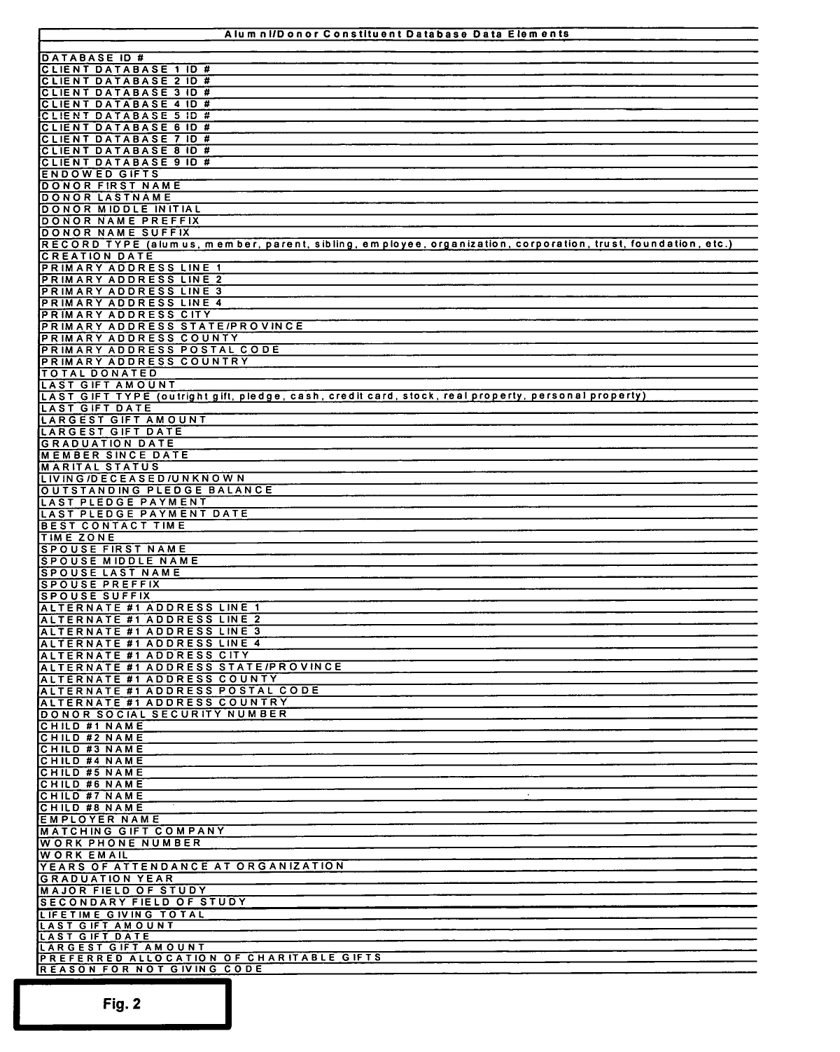

The organization 10 should also create a biographical profile of information about potential donor backgrounds it wants to have available at the time of solicitation. FIG. 2 provides such a listing although it is not necessarily complete. The necessity for such a comprehensive listing is to insure that an organization solicitor 50 will have all the necessary information needed for a successful interaction with a donor. For example: if a donor desires to be contacted by telephone at home on weekdays between the hours of six p.m. and eight p.m. (Eastern Daylight Time) and wants to be addressed as Doctor, such information could be placed in the potential member information data base (FIG. 2). It is readily apparent that some of the suggested information identified by line number in FIG. 2, won't be applicable, or known at the time of initial contact, but will have to be obtained at a later date. Also, some desirable information may not be listed: e.g. awards received, donor parent gifting information, etc. It will be up to each organization to decide what information it desires its solicitors to have when contacting potential donors.

Creation of a paper and electronic email thank you notification system by an organization 10 will also have to be created: e.g. all thank you notes for gifts over $1,000 and less than $2,000 will be signed by the head of alumni relations, gifts over $2,000 will be signed by the president, gifts under $1,000 will be signed by the treasurer of the organization. Perhaps some funds need to be acknowledged by the head of a department. Whatever scheme of acknowledgment is deemed advisable by an organization 10 needs to be developed, so that when a solicitor 50 makes a successful contact and records such at the “last gift amount” line of the database (FIG. 2), a proper thank you note will be created and sent to the proper person for signature. Likewise each of the gift amount lines of FIG. 2 may have to be updated because of a gift. Additionally other personal data will perhaps need to be updated.

It would be expensive and time consuming for an organization 10 to not only create the listings identified supra, but also to do the programming and maintenance. That would waste valuable organization 10 resources.

Normal credit card companies 20 have developed systems which receive charges from many different merchant 40 input areas (stores and store areas) and different individuals and in response thereto create individual billing amounts and payment of fuids to the different input areas, all in response to a swipe of a credit card in a machine that has created an electronic bill, say in response to a bar code on an item of merchandise. These credit card companies 20 also have personal information on each card member.

Thus the programming necessary to maintain and update the information in FIG. 2 exists and what would be required is to have some system to translate the organization's material into a format used by credit card companies 20.

For example, it is not unusual that credit card bills list purchases by type of store, e.g. restaurants, grocery, gas stations, etc. as well as year end summaries using similar headings. This division would be akin to the listing of an organization's usage, e.g. Walmart has many locations (areas of usage) where multiple credit card machines can be found and where food, electronics and other merchant items can be classified. The credit card company 20 can use that information to properly identify the purchaser, the seller, the areas of the seller's business, the place for payment and obviously prepare many other reports.

Hence to reduce costs an organization should try to approach a credit card company 20 to see if it could get the credit card company 20 to handle its solicitation data base.

As is well known, credit card companies 20 mail out thousands of credit card applications daily. Credit card companies 20 are always on the lookout for new members. This need for new members could be used by an organization 10 for providing it with low cost or free data base management system. For example: if the University of Maryland wanted VISA to maintain its alumni data base, it could partner VISA with the university to have VISA issue a VISA credit card embedded with all of the student identification information that a conventional stand-alone student ID card currently holds, allowing a student to: use dining service meal plans; gain entrance to campus buildings; check out books from the university library; and use the VISA card as either a conventional credit card, or a debit card that debits a student's personal or campus account whenever the student needs to purchase items, on or off campus, from merchants that accept VISA cards for payment. When the student graduates, the card can still be used as an alumni ID and a conventional debit or credit card with the important distinction of being easier to track and update more efficiently than current methods. The alumni address information can then be shared with the partner university or institution. The bank or credit card company gets a more loyal customer and the university or charitable organization will receive lower cost address update information from the financial institution maintaining the card holder's most recent address and contact information. The university could request electronic copies of that information in batches (e.g. 20 names) to give to solicitors 50 who would contact the potential gift grantors during any of its fuiding drives. The solicitors 50 would enter the update gifting and donor information on appropriate lines of FIG. 2 at the time of the solicitation and the credit card company 20 would report the same to the organization 10, remitting the credit card funds and creating the thank you letter reporting scheme of the organization 10 as well as depositing the credit card fuids at the direction of the university. Alternatively the solicitor 50 could report the information to the organization which would then relay the information to the credit card company.

Any updates to a potential donor's information data base could be updated when directly received by the credit card company 20.

The student or alumnus could obtain a credit card and could receive an annual listing of all gifts to the university at the end of the year.

The credit card could have a picture of the University Seal. Major donors could have other pictures added to their cards, or be automatically transferred to gold, platinum, etc. status when gifting of certain amounts are received.

The University could have its alumni and students use their cards for admission(s) into various campus activities e.g. library attendance and book borrowing, sport and social events, etc., and thus obtain entrance and use information about its students and alumni. This would be enhanced by having student pictures on the cards. Also gifting by credit card provides faster receipt of funds and if used to create thank you notes, a reduction in costs to acknowledge donations and a method to track thank yous to insure prompt acknowledgement of gifting.

While the term “credit card” is used in this application, the term is intended to include: normal credit cards, prepaid cards, debit cards, or any electronic stored value card or electronic chip, by itself, or on a badge, key chain, flash pass, etc.

While the invention has been described as using a credit card company 20 such is not necessary, since the necessary data base management could be performed by a software knowledgeable company that doesn't issue credit cards.

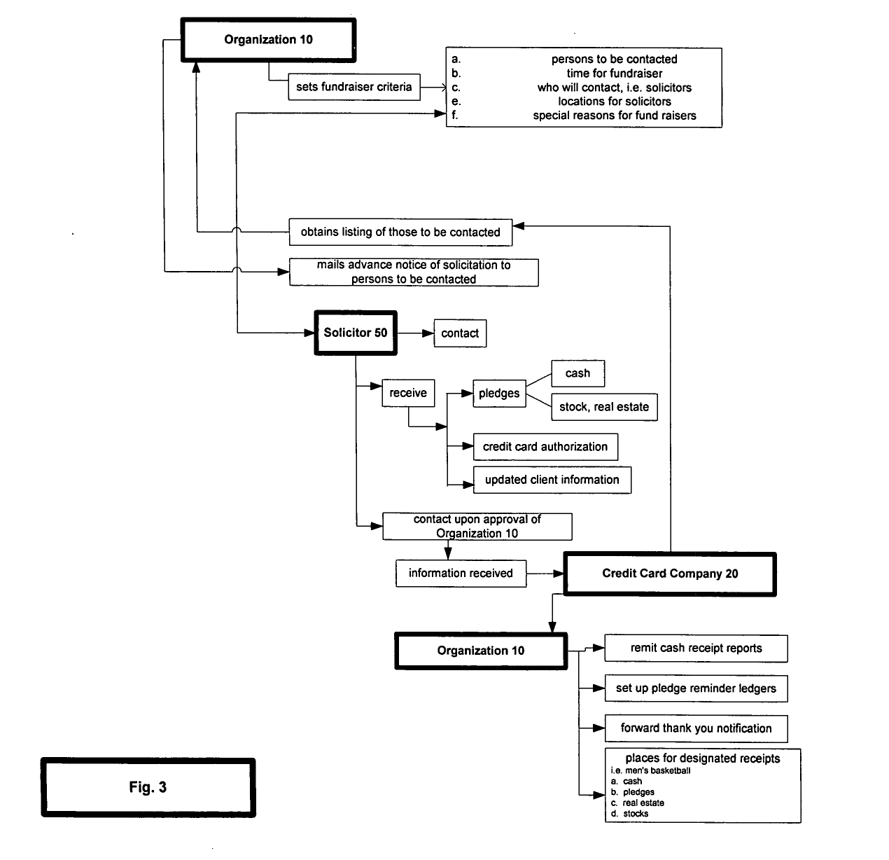

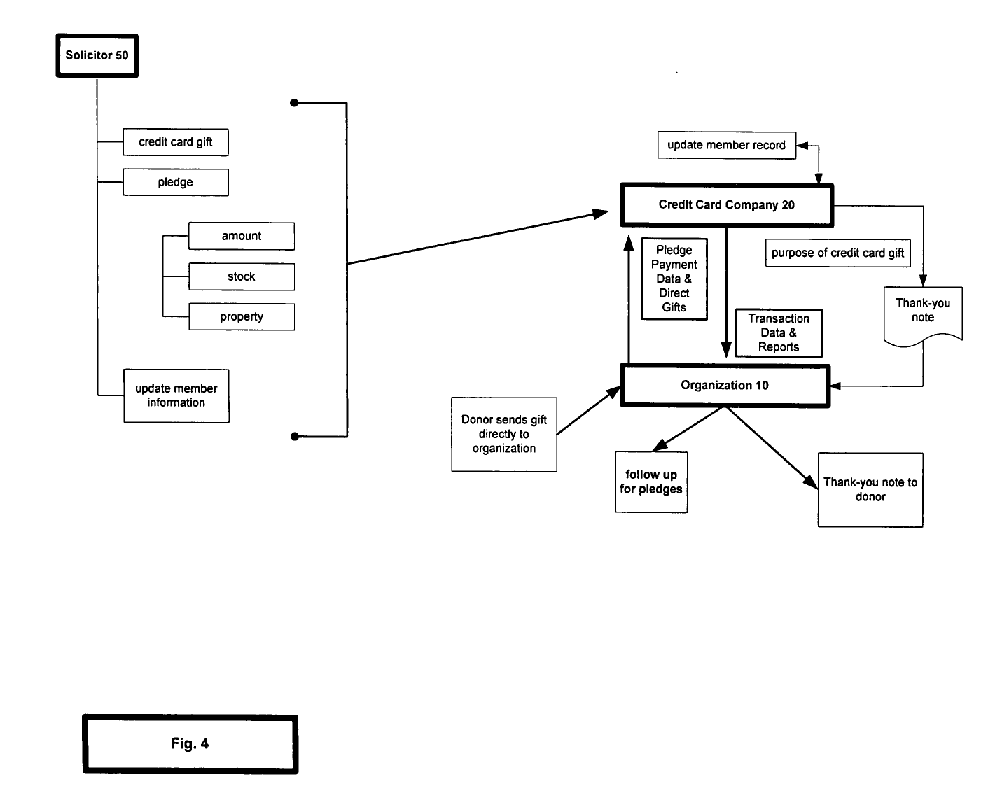

FIG. 1 shows a schematic of the solicitation system. As explained, when an organization 10 desires to utilize the system, it shall create: a listing of usages for funds received 11; a listing of potential member data base 24 (see also FIG. 2); format (contents) of thank you notes 13 and criteria 14 for signing (organization official who will sign thank you note dependent on usage for and amount of funds donated); the method of transmitting the thank you note to the donor; and creates when, where, and how solicitation drives will be conducted. As concerns solicitation drives 15, the potential group solicited could be limited by the usage contemplated by the organization, e.g. funds for a new business administration building could be limited to business administration graduates who were previous donors and would accept mail solicitations. This information can be found at different lines in the data base of FIG. 2. FIG. 3 shows an exemplary fund posting system, and FIG. 4 shows an exemplary follow-up to a solicitation. Lastly, the organization 10 must find a company 20 (preferably a credit card company) that will carry out the solicitation system.

Before the first use, past giving records from the organization 10 should be entered into the system by the credit card company and potential donor 30 identification information also entered.

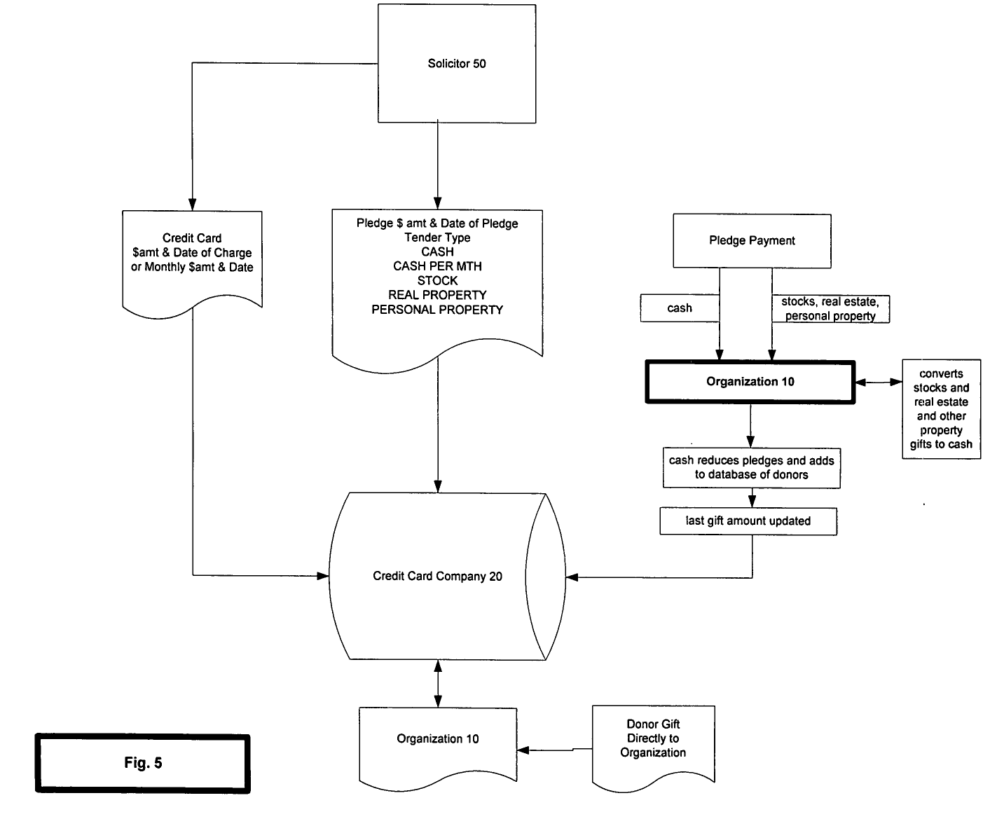

FIG. 5 shows a general activity process for a prospective donor record. Upon being solicited the donor 30 may authorize a credit card charge. The solicitor 50 would note the amount and date and whether multiple monthly payments should be charged. The solicitor 50 would then enter that information into a system which could correct the credit card company 20 records and which entry would create the thank you note letter for signature and mailing according to the organization's 10 pre-established plan. The system normally should be controlled by the organization 10, to limit solicitor ability to access donor records at the credit card company.

If the gift was for a future pledge, the solicitor would enter the information under the pledge categories of FIG. 2. This information would then be received by the system and forwarded to the credit card company 20 which would create the agreed upon thank you note and how to complete your gift form letter to be sent to the donor by the organization 10.

When a pledge is fulfilled, the organization 10 will report receipt to the system and to the credit card company 20 while reducing the amount of the pledge in FIG. 5. If the receipt and pledge amounts differ, a discrepancy report should be created so as to be reviewable by the organization 10 to see if any follow up is necessary. Also the agreed upon thank you note should be created and sent out. Additionally, gifts made directly to the organization 10 should also be entered into the system.

Periodically the system should provide reports to the organization 10 by activity, showing for example:
a—credit card receipts by month/year
b—cash receipts by month/year
c—unfulfilled pledges by month/year
d—total pledges dropped for non-payment [The organization 10 should set a time period for writing off unfulfilled pledges.]
e—persons with unfulfilled pledges

Donor employer records should have a box for marking whether or not the employer has a matching fund program (see FIG. 2). The solicitor 50 could note this when soliciting and obtain authority to send the proper paperwork to the donor or the donor's employer to obtain advantage of the matching program.

Because of the information in the system various prospective solicitation lists could be created by targeting donors with:
a—donations of more than $100
b—donations of more than $1,000
c—donations of more than $10,000
d—cumulative gifting amounts
e—changes in gifting patters (e.g. double last year's gift)
f—personal information (e.g. lottery winner, job promotion, etc.)

The credit card company 20 desiring to carry out ten solicitation system has to receive and accept the use areas, potential membership donor information and thank you formats created by the organization 10. The credit card company then devises a system for transmitting a donor data base, a system for reporting pledges and remitting funds and for transmitting thank you note commands and for creating credit cards for the potential member. The credit card company 20 will continue to process credit purchases from merchants 40 in response to sales reports from potential members 30 to pay the merchant 40 and send out debit notes to potential members 30.

The organization potential members 30 (prospective donors) need to provide membership information to forward to the credit card company 20 by the organization 10, make pledges which are transmitted to the credit card company 20 via the solicitors 50 and from the organization 10, and use the credit card in its normal manner to make purchases from merchants 40.

If an organization 10 decides to solicit fuids for a special purpose (e.g. electrical engineering department equipment) it would generally follow the FIG. 3 system. The organization 10 would first decide what fuids would be solicited for, who would be contacted, when the fund raiser would occur, who will do the contacting and the content of pre-mailings for the solicitation. For example, if new lab equipment were needed for the electrical engineering department, the chair of the department could approach the dean for permission to solicit fuids from alumni. Say the school currently has twenty electrical engineering students, the chair of the department may suggest that these students do the solicitation, since they are very knowledgeable of the need and can speak and understand the lingo of the need. The chair of the department could further suggest that electrical engineering graduates from the last six years be contacted for possible donations. The chair of the department would draft a pre-solicitation announcement for those to be contacted explaining the need for a solicitation.

The organization 10 would then approve the solicitation drive, or modify it, such as suggesting each engineering department join in (e.g. chemical engineering, mechanical engineering, combustion engineering, etc., all soliciting for new equipment at the same time.)

The organization 10 will then obtain a listing of all their engineer graduates for the last six years from the credit card company 20 and send (mail-email) a copy of the advance solicitation notice alerting the potential donors 30 of the upcoming solicitation. Limiting those to be solicited to engineering graduates from the last six years has advantages. They are more familiar with the physical condition of the respective engineering department in comparison with equipment they now work on. They are generally of the same age group as the solicitors 50 (current students) so they can more easily relate to one another. Other selection criteria could be used. For example, if a solicitor 50 was from the New York City area, that solicitor 50 could be given a listing of only New York, Connecticut and Northern New Jersey graduates.

After the pre-solicitation letter is sent out, the organization 10 will get the credit card company 20 to give it a list of prospective donors 30 in accordance with the criteria selected and these listings will be given to the solicitors 50 to contact. If contact cannot be made, the prospective donor information could be placed in a follow up category for re-contacting.

The solicitor 50 would try to obtain a donation. The preferable gifting method would be to allow the credit card to be used (the donation of money would be almost instantaneous) and some people believe that credit card donations would be larger. If a credit card is authorized to be used, most organizations 10 would want another solicitor 50 to talk to the donor 30 and confirm the intention to gift. Then as shown in FIG. 4, the donor's file history at the credit card company 20 would be updated with gift information (amount, date and purpose) by the solicitor 50. The credit card company 20 would then inform the organization 10 of the gift and trigger the agreed upon thank you routine based on the amount of the gift as explained supra. If the gift is a pledge as opposed to a credit card gift, the pledge data box will be updated and this would cause an agreed upon thank you note to be created. The note should include a statement such as, “enclosed for your conveyance is a self-addressed stamped envelope for return of your pledge.” If the gift is real property or stocks, the thank you note should include a statement such as, “Please contact John Doe@phone number (e-mail) to arrange for the transfer of your gift.” Whenever there is a pledge (not a credit card cash transaction), the credit card company 20 should provide a follow up listing to the organization 10 listing the donor's name, the pledge, purpose for the pledge, contact information, date of the pledge in accordance with an agreed follow-up system with the organization. For example, large donations may have a two week follow-up, small donations a three week follow up, while property and stock donations may have a shorter time.

The organization 10 needs to inform the credit card company 20 when receipt of the pledge occurs so the donor record can be changed (delete pledge entry and enter amount of gift) and so the follow up system can be disconnected.

The organization 10 may decide to stop follow-ups after the third unsuccessful payment attempt and would thus need to contact the credit card company 20 to correct the donor record and delete the follow-up trail.

The organization 10 would want periodic reports from the credit card company 20 as to gifts (credit card, cash, other, pledged but not paid) and purposes therefore so the organization 10 can insure that it is spending the gifts for the purposes directed by the donor.

Some donors may desire to pay a specified sum of money monthly or quarterly and the follow-up system should provide for this.

Some organizations want to know what is happening with their large donors, in which case the credit card company 20 could send to the organization reports on large donors, monthly or quarterly as desired.

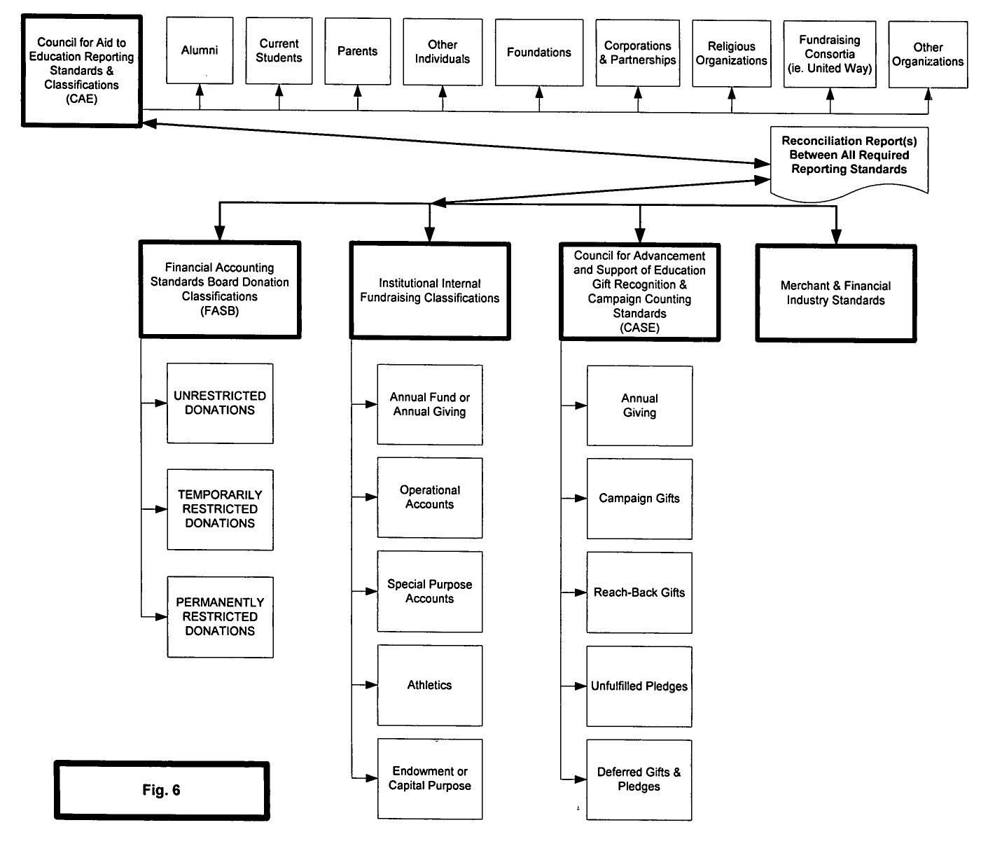

FIG. 6 indicates the normal sources of donations for different types of schools. The listing of FIG. 2 should provide a client database identifier source which corresponds to:
students
alumni
parents
other individuals (e.g. teachers, instructors, etc.)
foundations
corporations and partnerships
religious organizations
fundraising consortia (e.g. United Way)
other organizations

In this manner, the organization 10 can receive reports indicating gifting by each of these sources. The Council for Aid to Education collects such information. It is recognized, of course, that each of the sources will not require or have all the information allowed for by FIG. 2.

Students and alumni should have their photograph on the card issued by the credit card company 20 so that the card can double as an identifier for the individual at organization 10 functions. The background of the card could be changed upon graduation to show a changed status.

Students, alumni, parents and other individuals could also be provided with a credit card organization identifier which can also be used as a normal credit card for charging merchant purchases.

The system can provide an indication of the three basic types of gifting:
a—Unrestricted donations (donation without a specified donor purpose)
b—Temporarily Restricted Donations (Donors specify specific usage for the gift, e.g., scholarship, building fund, etc.)
c—Permanently Restricted Donations (Donor gives a sum of money which is set up in an investment fimd, the interest of which will be used for the donor's specified purchase.)
   These three types of gifting are a required reporting mode for the Financial Accounting Standards Board (FASB). By having the FIG. 2 system provide identifiers for these types of gifts will allow for an automated FASB report. All that would be required is that each gift when entered into the system be properly coded.

By having the system of FIG. 2 provide an identifier for the solicitation event that caused the donation will allow the system to automatically report the success of different organizational solicitation drives (see FIG. 6); e.g., an Annual Fundraising Campaign;

Law School Moot Court Competition Campaign; Engineering Endowment; College Birthday Campaign; Athletics, etc.

The Council for Advancement and Support of Education Gift Recognition Campaign Counting Standards (CASE) wants reports for:
a—annual giving
b—campaign gifts
c—reach back gifts
d—unfulfilled pledges
e—deferred gifts and pledges

### By identifying gifts in FIG. 2 using this CASE criteria, the system can automatically provide a report for CASE as shown in FIG. 6.

Not only are there standards for fund raising activities, there are requirements and standards for merchant credit card companies, banks, and other service providers which also need to be complied with. These requirements change with regularity, but as shown in FIG. 6, the invention contemplates providing safeguards to include these requirements and standards.

An organization adopting this system should go back through its current fundraising records and input its old data into the system.

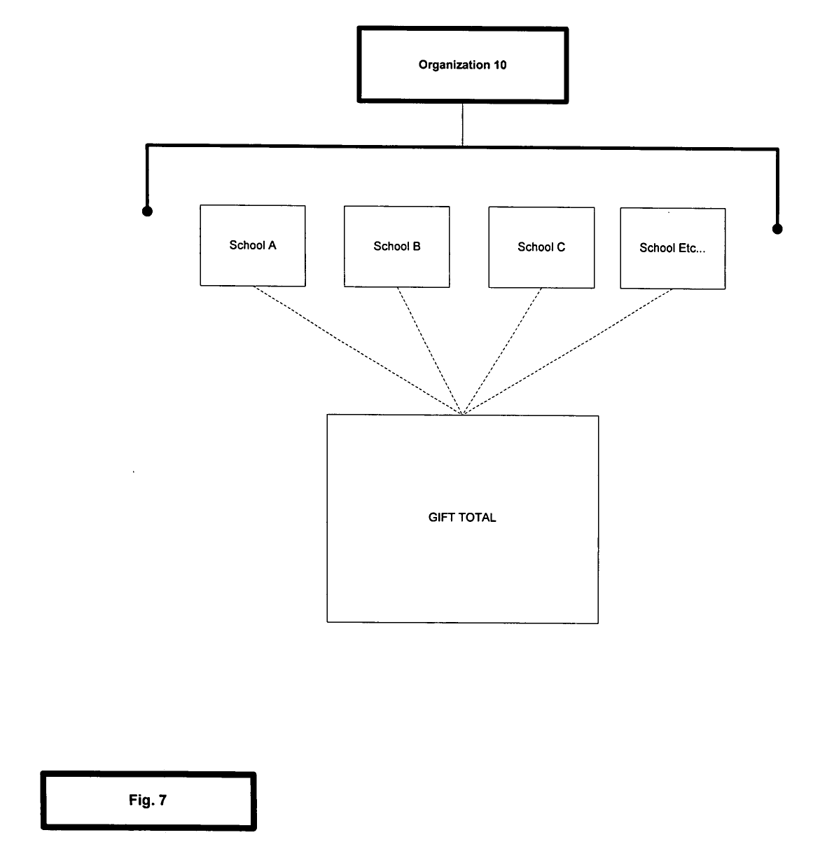

In some organizations there is jealousy between different organization groups with some groups desiring to protect the identity of their big donors, for fear that other organization units may try to solicit them and thus reduce the amount of gift they might normally receive. FIG. 7 shows an organization 10 (perhaps a university) with multiple schools. The system will allow for a school identifier for each donor in FIG. 2 so that separate reports can be given to each school (with a combined total for the university) without availability of donor information between schools if such is desired.

There is a wide range of federal, state and industry standards which currently affect how organizations engaged in constituent fundraising and other relationship services outsource such services to third party electronic commerce intermediaries. The proprietary system of the invention could contain safeguards to protect the privacy of databases created, transmitted and maintained. Specific arrangements to restrict the interception, access or disclosure of communications and records are considered part of this system. Since these types of restrictions and protections can and do change, specific listings of current restrictions have not been presented. To implement these items, protocols and practices to secure transactions are utilized. This system accommodates off-line and on-line features for both credit and debit cards.

Methods for categorizing gifts and subjective changes to gift counting practices by fundraisers can affect the presentment and communication of financial disclosures surrounding fundraising work. This invention promotes capabilities to avoid reconciliation discrepancies between the financial and fundraising reports provided to an organization's constituents in order to provide sufficient comfort regarding the accuracy and completeness of the information communicated.

It is not unusual for a not-for-profit organization with segmented operating units to utilize multiple systems and networks for its internal functions and activities. For example, the information management system for tracking alumni and other fundraising within a university's law school may be totally separate, different, and perhaps incompatible with the database utilized by the school of engineering at the same university.

At the same time, the financial systems utilized by the fundraising staff at an institution may be different from or inconsistent with respect to the central financial recordkeeping for the entire organization. For example, fundraising processing and counting systems itemizing separately each gift transaction of each donor may be designed differently from ledger and accounting systems which summarize transactions reporting and disclosure standards. This invention applies integrated capabilities to ensure consistent transaction processing and reconciliation across databases. The reporting system to the organization 10 contemplates reports both for fundraising needs as well as financial needs.

Contemporary relationship-building strategies emphasize effective use of institutional information capital. Constituent profiles, characteristics affecting giving capabilities and giving preferences are key elements in crafting public solicitations for fundraising and other communication strategies. This invention for constituent information management presents a valuable knowledge triangle: information retention, analysis and empirical-based activities.

Donors and other constituencies are currently showing an increasing interest in the reporting on the use of gifts in accordance with donors' general or specific intentions. The system is designed to maintain the basic integrity of the internal recordkeeping and control systems governing fimd raising.

Currently there is no simple rule of thumb or clear standards for institutional reporting of fundraising results. Categories of annual giving, major gifts, capital gifts or deferred gifts are not readily discemable for demarcation.

At its core the system of this invention seeks a high degree of accuracy, completeness and consistency. This system permits flexibility to balance between positive and negative factors surrounding the financial results from fundraising operations.

Although the present invention has been described and illustrated in detail above, it is to be clearly understood that this is done by way of illustration and example only and is not to be taken by way of limitation. The spirit and scope of the present disclosure are to be limited only by the terms of the appended claims.

We claim:

1. creating an organization membership data base solicitation system comprising:
having a membership application completed for each prospective donor member which applications contain sufficient information to support a credit card application and student membership identification information sufficient to support use as one of a student and organizational identification card for use in a meal plan system, class or event registration system, library card system, class registration and student records administration system as well as personal information including at least one of date of prospective membership, area(s) of activity at the organization, date of entry into the organization, and family information including at least one of names of spouse, children and nickname of prospective donor;
developing a membership information data base comprising at least a place for information concerning dates and dollar amount of the last gift to the organization, requested area(s) for the last gift usage, mail address of donor, communication address of donor, and name of donor;
developing a list of gift usage identifiers describing at least one of area(s) and time(s) for gifting to the organization;
obtaining a credit card company or other third party service provider that will accept the membership applications from a plurality of prospective donor members with the developed membership information and the developed list of gift usages and issue a credit type card to the prospective donor member, provide a data base containing the accepted information and provide to the organization an accessible data link entry of the accepted information for organizational membership and updating purposes;
having the credit company accept gifting information from the donor member and the organization and periodically forwarding to the organization reports showing gifting funds and areas of use therefore, and donor information.

2. The solicitation system of claim 1, wherein at least some of the areas of usage have special acceptance correspondence to be sent to the donor from different members of the organizations dependent on the amount and usage of the gift.

3. The solicitation system of claim 1, wherein the prospective members can use the credit type card to make normal credit purchases in a manner similar to normal credit type card purchases.

4. The solicitation system of claim 2, wherein the prospective members can use the credit type card to make normal credit purchases in a manner similar to normal credit type card purchases.

5. The solicitation system of claim 3, wherein the organization can access information from the credit company that relates to information provided by the organization to the credit company and to updates thereof by electronic request and wherein normal credit purchase information of the prospective donor member is denied to the organization.

6. The solicitation system of claim 5, wherein the organization can access information from the credit company that relates to information provided by the organization to the credit company and to updates thereof by electronic request and wherein normal credit purchase information of the prospective donor member is denied to the organization.

7. The solicitation system of claim 1, wherein the donor data base information has the ability to accept information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.

8. The solicitation system of claim 2, wherein the data base information has the ability to accept and process information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization
donor's minor area at the organization;
donor's last gift amount to the organization;
donor's last year's gifts amount;
donor's last five (5) years' gifts amounts;
donor's allocation of gift usage requested by donor;
donor's current gift amount and usage.

9. The solicitation system of claim 3, wherein the data base information has the ability to accept and process information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.

10. The solicitation system of claim 4, wherein the data base information has the ability to accept information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.

11. The solicitation system of claim 5, wherein the data base information has the ability to accept information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.

12. The solicitation system of claim 6, wherein the data base information has the ability to accept information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.

13. The solicitation systems of claim 1, wherein the credit type card is provided with a symbol evidencing the organization and wherein the credit type card is provided with visual indications that reflect the amount of donations from the prospective donor member to the organization.

14. The solicitation systems of claim 2, wherein the credit type card is provided with a symbol evidencing the organization and wherein the credit type card is provided with visual indications that reflect the amount of donations from the prospective donor member to the organization.

15. The solicitation systems of claim 3, wherein the credit type card is provided with a symbol evidencing the organization and wherein the credit type card is provided with visual indications that reflect the amount of donations from the prospective donor member to the organization.

16. The solicitation systems of claim 4, wherein the credit type card is provided with a symbol evidencing the organization and wherein the credit type card is provided with visual indications that reflect the amount of donations from the prospective donor member to the organization.

17. The solicitation systems of claim 5, wherein the credit type card is provided with a symbol evidencing the organization and wherein the credit type card is provided with visual indications that reflect the amount of donations from the prospective donor member to the organization.

18. The solicitation systems of claim 6, wherein the credit type card is provided with a symbol evidencing the organization and wherein the credit type card is provided with visual indications that reflect the amount of donations from the prospective member to the organization.

19. Creating an organizational membership database solicitation system comprising:
having a membership application filled out for each prospective donor member which contains sufficient information to support a credit card application as well as personal information including at least one of date of prospective membership, area(s) of activity at the organization, date of entry into the organization, and family information including at least one of names of spouse, children and nickname of prospective donor;
developing a membership information data base comprising at least a place for information concerning date and dollar amount of last gift to the organization, requested area(s) for the last gift usage, mail address of donor, communication address of donor, and name of donor;
developing a list of gift usage identifiers describing at least one of areas and times for gifting to the organization;
obtaining a company that will accept the membership applications for a plurality of prospective donor members with the developed membership information and the developed list of gift uses and provide a data base thereof for the organization along with an accessible data link entry of the accepted information for the organization's use and for updating purposes;
having the company provide a system for collecting pledged fund information by prospective donor members which system permits and identifies prospective donor members suggested uses for the members' pledged funds and;
having the company provide periodic reports of pledged funds.

20. The solicitation system of claim 19, wherein at least some of the areas of usage have special memory addresses that receive the gifting information from the credit company and create acceptance correspondence to be sent to the donor from different members of the organizations dependent on the amount and usage of the gift.

21. The solicitation system of claim 19, wherein the data base information has the ability to accept information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.

22. The solicitation system of claim 19, wherein the company accepting information provides the organization with periodic reports showing gifts by credit card and the donor and usage for the last gift along with a thank you letter to send to the donor by the organization as well as periodic reports for pledges showing pledge, description, donor and usage along with a follow-up thank you letter to send to the donor which pledge follow-up letter includes instructions on transmission of the gift to the organization.

23. The solicitation system of claim 20, wherein the company accepting information provides the organization with periodic reports showing gifts by credit card and the donor and usage for the last gift along with a thank you letter to send to the donor by the organization as well as periodic reports for pledges showing pledge, description, donor and usage along with a follow-up thank you letter to send to the donor which pledge follow-up letter includes instructions on transmission of the gift to the organization.

24. The solicitation system of claim 19, wherein the system can create prospective listings of potential donors, based on any one of gifting amounts, donor location, donor education, donor accomplishments, gifting purpose, and donor employer.

25. The solicitation system of claim 20, wherein the system can create prospective listings of potential donors, based on any one of gifting amounts, donor location, donor education, donor accomplishments, gifting purpose, and donor employer.

26. The solicitation system of claim 21, wherein the system can create prospective listings of potential donors, based on any one of gifting amounts, donor location, donor education, donor accomplishments, gifting purpose, and donor employer.

27. The solicitation system of claim 22, wherein the system can create prospective listings of potential donors, based on any one of gifting amounts, donor location, donor education, donor accomplishments, gifting purpose, and donor employer.

28. The solicitation system of claim 23, wherein the system can create prospective listings of potential donors, based on any one of gifting amounts, donor location, donor education, donor accomplishments, gifting purpose, and donor employer.

29. Creating an organizational database solicitation system comprising:
developing a membership donor information database comprising space for at least:
a—donor identifying information
b—donor contact information
c—date and amount of donor gift
d—whether use for the donor gift is unrestricted
e—whether use for the donor gift is temporarily restricted
f—whether use for the donor gift is permanently restricted
g—use for the donor gift if specified
obtaining a company that will maintain the information database
providing for organizational input to update the information database upon receipt of donations, and
having the company produce periodic reports specifying the total of at least items c-g, above.

30. The solicitation system of claim 29, wherein the database information has the ability to accept information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.

31. The solicitation system of claim 19, which has the ability to accept information comprising:
developing a membership information database comprising space for at least:
a—donor identifying information
b—donor contact information
c—date and amount of gift
d—whether use for the gift is unrestricted
e—whether use for the gift is temporarily restricted
f—whether use for the gift is permanently restricted
g—use for the gift if specified
providing for organizational input to update the information database upon receipt of donations, and
having the company produce periodic reports specifying the total of at least items c-g, above.

32. The solicitation system of claim 31, which has the ability to accept information comprising:
donor's first name;
donor's last name;
donor's title;
donor's social security number;
donor's mail address;
donor's email address;
donor's phone number;
donor's cell phone number;
donor's spouse name and birthdate;
donor's children's names, gender, and birthdates;
donor's marriage date;
donor's divorce date and divorced spouse's name;
donor's dates of attendance at the organization;
donor's date of graduation from the organization;
donor's major area at the organization;
donor's minor area at the organization;
donor's last gift amount to the organization;
donor's last year's gifts amount;
donor's last five (5) years' gifts amounts;
donor's allocation of gift usage requested by donor;
donor's current gift amount and usage.
